(19) United States
(12) Patent Application Publication
(10) Pub. No.: US 2025/0081069 A1
(43) Pub. Date: Mar. 6, 2025

(54) ENHANCED USER EXPERIENCE AND MOBILITY ROBUSTNESS WITH CONDITIONAL HANDOVER IMPLEMENTATION TECHNIQUE IN 5G STANDALONE O-RAN NETWORK

(71) Applicant: DISH Wireless L.L.C., Englewood, CO (US)

(72) Inventor: Manish Uniyal, Parker, CO (US)

(21) Appl. No.: 18/459,024

(22) Filed: Aug. 30, 2023

(51) Int. Cl. H04W 36/30; H04W 36/00; H04W 36/36

(52) U.S. Cl. CPC H04W 36/304; H04W 36/00835; H04W 36/00837; H04W 36/362

(57) ABSTRACT

A wireless device includes a transceiver, sensing circuitry, and an electronic processor. The transceiver receives electromagnetic wave signals emitted wirelessly from a plurality of cells. The sensing circuitry measures a signal from a source cell to obtain a signal to interference and noise ratio (SINR) and a received signal reference power (RSRP) for the signal. When the transceiver receives a reconfiguration message from the source cell during a time span, the electronic processor controls a legacy handover that shifts communication with the transceiver from the source cell to the target cell. When a conditional handover state exists, the electronic processor controls a conditional handover that shifts communication with the transceiver from the source cell to the target cell. The conditional handover state includes an absence of the legacy handover, the RSRP being below an RSRP threshold and the SINR below an SINR threshold.

### BACKGROUND

A conditional handover is a handover that is executed by user equipment (UE) when one or more handover execution conditions are met. The user equipment starts evaluating the execution condition(s) upon receiving the conditional handover configuration and stops evaluating the execution condition(s) once a handover is executed.

### BRIEF DESCRIPTION OF THE DRAWINGS

The accompanying drawings, which are incorporated in and form a part of this specification, illustrate examples of the disclosure and, together with the description, explain principles of the examples. In the drawings, like reference symbols and numerals indicate the same or similar components.

FIGS. 1A and 1B illustrate a communication system.

FIG. 2 illustrates a wireless device.

FIG. 3 illustrates the wireless device in the communication system before handover.

FIGS. 4A, 4B, 4C and 4D are flowcharts that illustrate handover processing by the wireless device.

FIG. 5 illustrates an event trace diagram.

FIG. 6 is a Table that lists measurement report triggering events.

FIG. 7 illustrates the wireless device in the communication system after handover.

Like elements in the various figures are denoted by like reference numerals for consistency.

### DETAILED DESCRIPTION

The following describes technical solutions of this application with reference to accompanying drawings. Exemplary embodiments are described in detail with reference to the accompanying drawings. For the sake of clarity and conciseness, matters related to the present embodiments that are well known in the art have not been described.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Throughout the application, ordinal numbers (e.g., first, second, third, etc.) may be used as an adjective for an element (i.e., any noun in the application). Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section.

The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements. Thus, a first member, component, region, layer, or section referred to in examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and after an understanding of the disclosure of this application. Terms, such as those defined in commonly used dictionaries, are to be interpreted as having a meaning that is consistent with their meaning in the context of the relevant art and the disclosure of this application.

Unless otherwise indicated, like parts and method steps are referred to with like reference numerals.

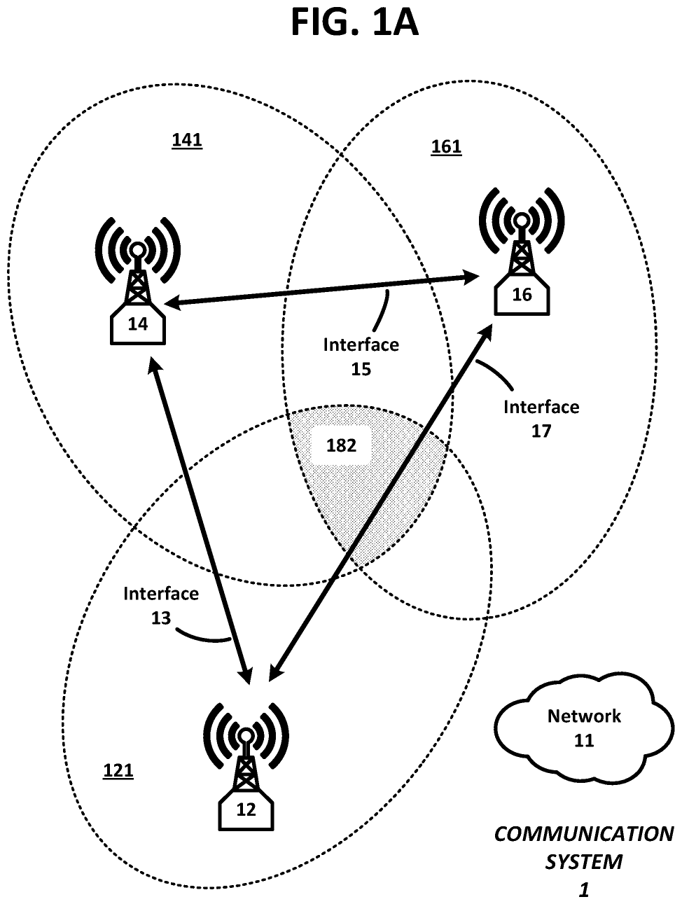

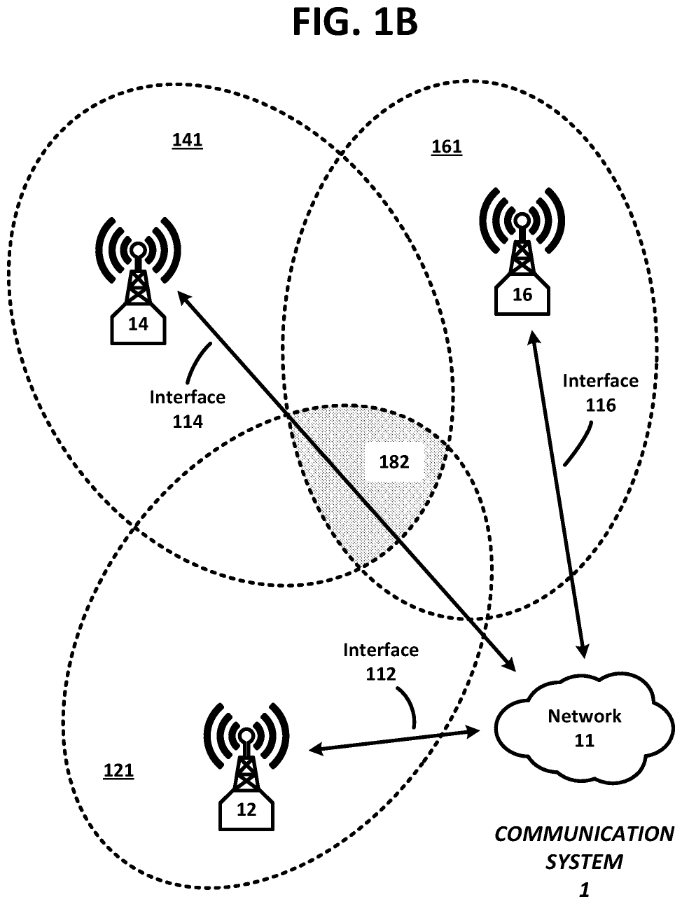

FIG. 1A illustrates a communication system 1. Components of the communication system 1 may include network 11, cell 12, cell 14, and cell 16. For simplicity and ease of understanding, the FIGS. 1A and 1B show a case in which only three cells 12, 14, and 16 are present in the communication system 1. However, the communication system 1 may include more than three cells. Cell 12, cell 14, and cell 16 may be cells of a same radio access type or may be cells of different radio access types. Any of the cells 12, 14, and 16 may be a base station, a macrocell, a microcell, a picocell, and/or a femtocell.

Overlapping coverage areas 121, 141, and 161 may exist in the communication system 1. Cell 12 is sited in geographic region 121 and provides communication coverage for geographic region 121. Cell 14 is sited in geographic region 141 and provides communication coverage for geographic region 141. FIGS. 1A and 1B illustrate geographic region 141 overlapping a portion of geographic region 121. Cell 16 is sited in geographic region 161 and provides communication coverage for geographic region 161. FIGS. 1A and 1B illustrate a portion of geographic region 121 and a portion of geographic region 141 overlapping portions of geographic region 161. Geographic region 182 in FIGS. 1A and 1B is where coverage areas 121, 141 and 161 overlap. Each of the cells 12, 14, and 16 may provide communication coverage for a respective coverage area.

As illustrated in FIG. 1A, each of the cells 12, 14, and 16 may electronically communicate with any other of the cells 12, 14, and 16. Specifically, interface 13 is a network interface that provides electronic communication between cell 12 and cell 14. Cell 14 may emit signals via interface 13 at signal levels that differ from the signal levels emitted from cell 12. Cell 12 may emit signals via interface 13 at signal levels that differ from the signal levels emitted from cell 14. Interface 15 is a network interface that provides electronic communication between cell 14 and cell 16. Cell 16 may emit signals via interface 15 at signal levels that differ from the signal levels emitted from cell 14. Cell 14 may emit signals via interface 15 at signal levels that differ from the signal levels emitted from cell 16. Interface 17 is a network interface that provides electronic communication between cell 16 and cell 12. Cell 12 may emit signals via interface 17 at signal levels that differ from the signal levels emitted from cell 16. Cell 16 may emit signals via interface 17 at signal levels that differ from the signal levels emitted from cell 15.

As illustrated in FIG. 1B, each of the cells 12, 14, and 16 may access network 11 by communicating electronically with the network 11. Specifically, interface 112 is a network interface that provides electronic communication between cell 12 and network 11. Interface 114 is a network interface that provides electronic communication between cell 14 and network 11. Interface 116 is a network interface that provides electronic communication between cell 16 and network 11. The network 11 may be a core network. The network 11 may a communication network that establishes communication from the cells 12, 14, and 16 to the internet and/or other communications networks.

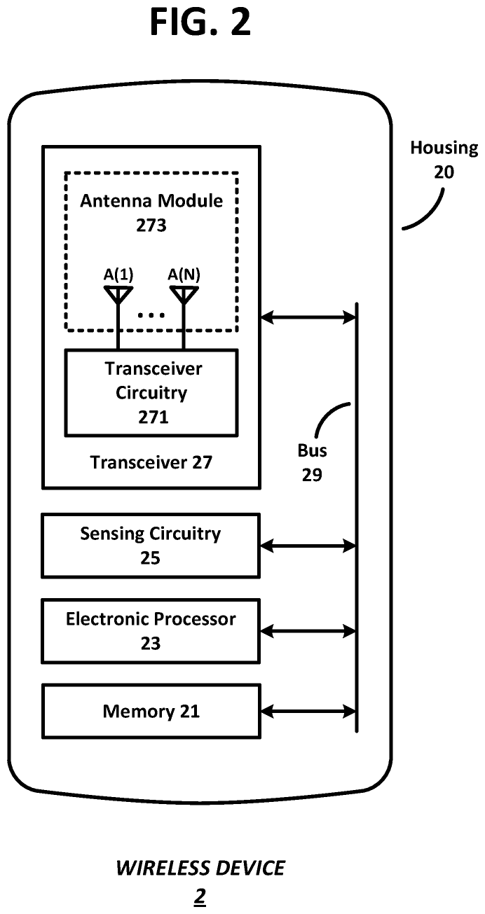

FIG. 2 illustrates a wireless device 2. The wireless device 2 may be a mobile electronic device. The wireless device 2 may be a stationary electronic device. The wireless device 2 may be a mobile device, a tablet, a telephone, a smartphone, a modem, a laptop, a computing device, a television set, or any other electronic equipment that is configured to wirelessly communicate with any of the cells 12, 14, and 16. Wireless device 2 may include housing 20, memory 21, an electronic processor 23, sensing circuitry 25, a transceiver 27, and a bus 29. As illustrated in FIG. 2, the memory 21, an electronic processor 23, sensing circuitry 25, a transceiver 27, and a bus 29 are encased in the housing 20. Bus 29 electronically interconnects the memory 21, the electronic processor 23, the sensing circuitry 25, and the transceiver 27.

Memory 21 may be non-transitory processor readable memory. Memory 21 may comprise read-only memory (“ROM”), random access memory (“RAM”), other non-transitory computer-readable media, or combination thereof. Memory 21 may be firmware. Memory 21 may store software for the wireless device 2. The software for the wireless device 2 may include program code. The program code may include program instructions that are executable by the electronic processor 23. Memory 21 may store filters, rules, data, or combination thereof.

The electronic processor 23 may control the wireless device 2. The electronic processor 23 may include a central processing unit (CPU), a graphic processing unit (GPU), a microprocessor, an application specific integrated circuit (ASIC), field programmable gate arrays (FPGA), or the like, and may have a plurality of cores.

The sensing circuitry 25 is electronic circuitry that may measure electromagnetic waves that the sensing circuitry 25 receives from the transceiver 27.

The transceiver 27 is electronic circuitry that may facilitate wireless communication between the wireless device 2 and the communication system 1. To facilitate wireless communication between wireless device 2 and the communication system 1, the transceiver 27 may wirelessly connect the wireless device 2 to the cells 12, 14, and 16.

The transceiver 27 may include an antenna module 273. The antenna module 273 may simultaneously emit and receive electromagnetic waves to wirelessly communicate with one or more cells 12, 14, and 16. The antenna module 273 may include a plurality of antennas A(1) to A(N), with “N” being an integer number greater than 1. The antenna module 273 may establish duplex communication with each of the cells 12, 14, and 16. This duplex communication may include two communication channels. One of the communication channels is an uplink for outbound transmission of uplink information from the wireless device 2 to any of the cells 12, 14, and 16. Another of the communication channels is a downlink for inbound reception of downlink information by the wireless device 2 from any of the cells 12, 14, and 16. For the wireless device 2 to achieve electronic separation of the communication channels from one another, the electromagnetic wave frequency for the downlink differs from the electromagnetic wave frequency for the uplink.

The antenna module 273 may emit an electromagnetic wave from the wireless device 2. The electromagnetic wave that the antenna module 273 emits from the wireless device 2 may be the uplink for receipt by any of the cells 12, 14, and 16. The uplink may be a scrambled signal. The transceiver circuitry 271 may superimpose uplink information onto a baseband signal for emission by the antenna module 273 via the uplink. By superimposing the uplink information onto the baseband signal, the transceiver 27 may convert the uplink information into the electromagnetic wave for emission by the antenna module 273. The antenna module 273 may emit the uplink information via the uplink at an uplink frequency while simultaneously receiving the downlink information via the downlink at a downlink frequency. The downlink frequency may differ from the uplink frequency.

The antenna module 273 may receive electromagnetic waves from the cells 12, 14, and 16. The electromagnetic waves that the antenna module 273 receives from any of the cells 12, 14, and 16 may be the downlink for receipt by wireless device 2. The downlink may be one or more scrambled signals. The transceiver circuitry 271 may transfer, to the sensing circuitry 25, any electromagnetic wave received by the antenna module 273 via the downlink. The transceiver circuitry 271 may also convert, into downlink information, any electromagnetic wave received by the antenna module 273 via the downlink. The antenna module 273 may receive the downlink information via the downlink at the downlink frequency while simultaneously emitting the uplink information via the uplink at the uplink frequency.

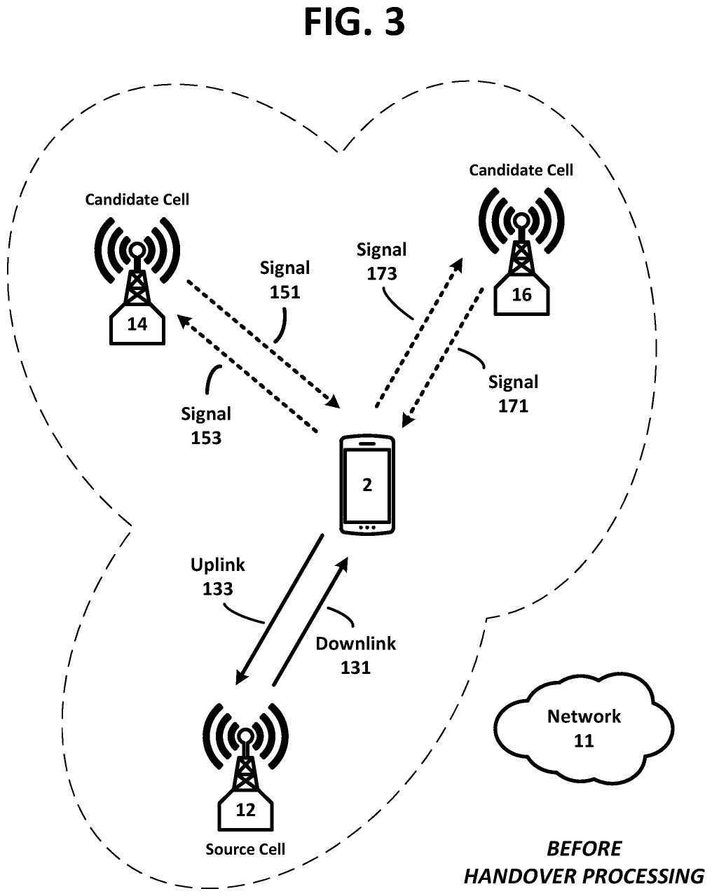

FIG. 3 illustrates the wireless device 2 in wireless communication with the cell 12 before a handover of the cell 12 to another of the cells 14 or 16. Downlink 131 in FIG. 3 is a communication channel between the wireless device 2 and the cell 12 for inbound reception of downlink information by the wireless device 2 from the cell 12. Uplink 133 is for outbound transmission of uplink information from the wireless device 2 to the cell 12. Signal 151 in FIG. 3 is a communication channel between the wireless device 2 and the cell 14 for inbound reception of downlink information by the wireless device 2 from the cell 14. Signal 153 is for outbound transmission of uplink information from the wireless device 2 to the cell 14. Signal 171 in FIG. 3 is a communication channel between the wireless device 2 and the cell 16 for inbound reception of downlink information by the wireless device 2 from the cell 16. Signal 173 is for outbound transmission of uplink information from the wireless device 2 to the cell 16.

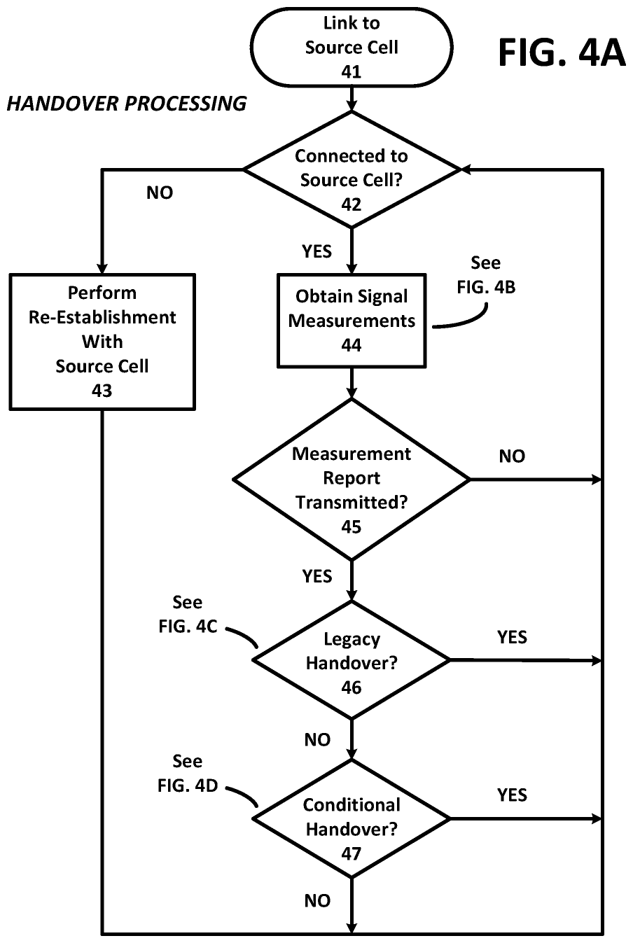

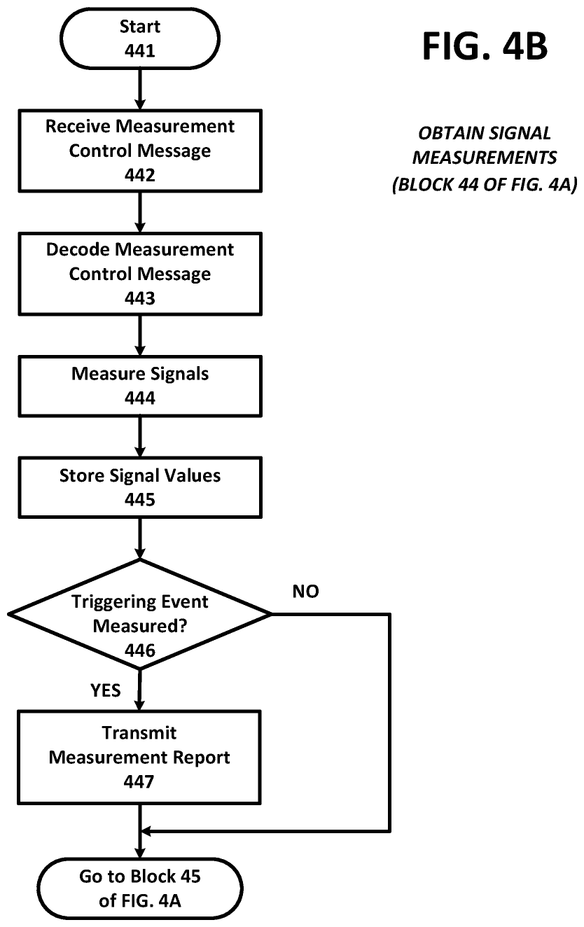

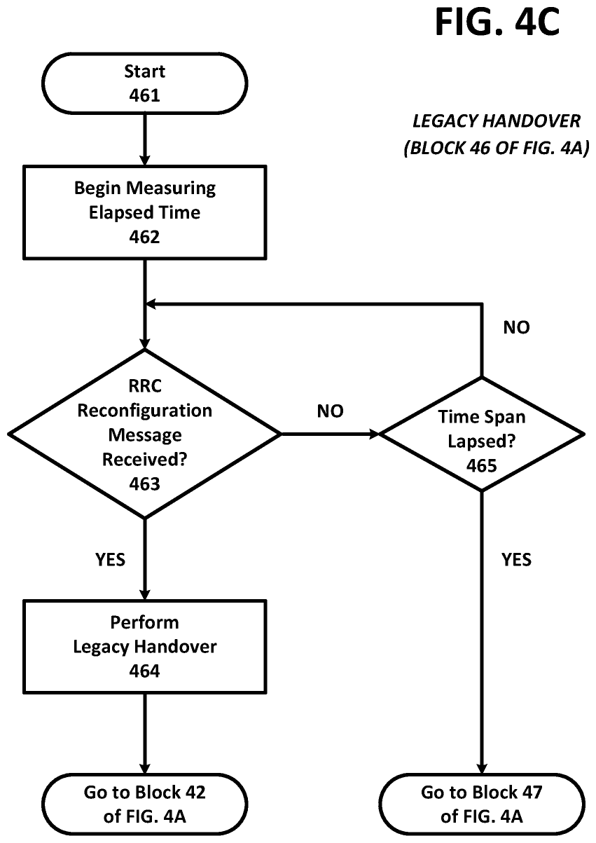

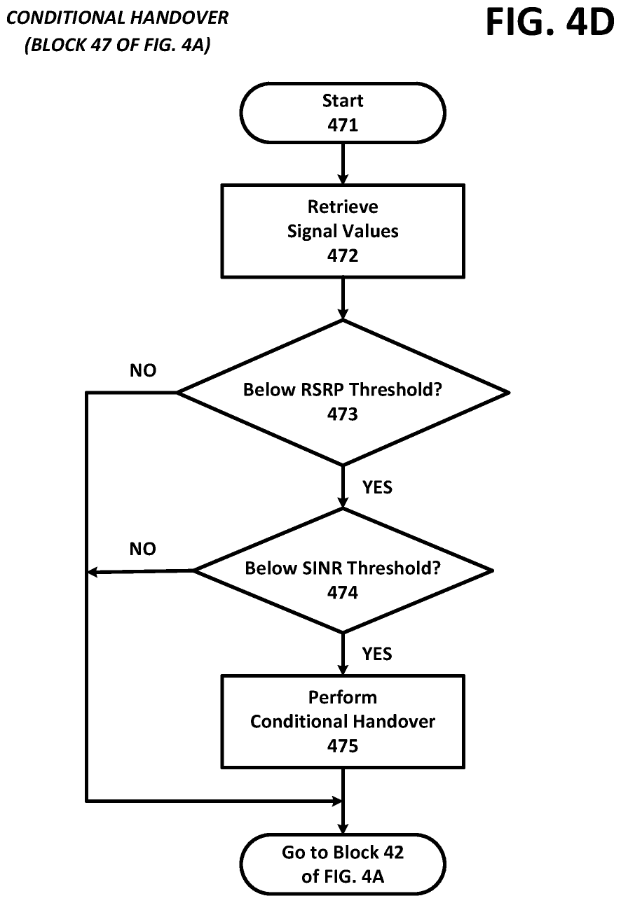

A handover is the transferring of communication between the wireless device 2 and the network 11 from a communication pathway that includes a source cell to another communication pathway that includes a candidate cell neighboring the source cell. Transference of the communication to the communication pathway that includes the candidate cell neighboring the source cell concludes the handover. Upon the transference of communication, the candidate cell will become a newly-designated source cell and the cell that was previously the source cell will become another candidate cell. An example of processing by the wireless device 2 during the handover is illustrated in the flowcharts of FIGS. 4A, 4B, 4C and 4D.

The electronic processor 23 may control the wireless device 2. The electronic processor 23 may include a central processing unit (CPU), a graphic processing unit (GPU), a microprocessor, an application specific integrated circuit (ASIC), field programmable gate arrays (FPGA), or the like, and may have a plurality of cores. Software that is stored in the non-transitory processor readable memory 21 may include the program instructions that are executable by the electronic processor 23. The electronic processor 23 may execute the program instructions. When executing the program instructions, the electronic processor 23 may perform processing for the wireless device 2. The software stored in the memory 21 may when, executed by the electronic processor 23, cause the electronic processor 23 to perform the handover processing illustrated in FIGS. 4A, 4B, 4C and 4D.

The handover processing in FIG. 4A begins at block 41, for example, when the antenna module 273 becomes in wireless communication with any of the cells 12, 14, and 16. FIG. 3 illustrates the wireless device 2 in wireless communication with the cell 12 before a handover of the cell 12 to another of the cells 14 or 16. Geographic region 182 in FIG. 1A is where coverage areas 121, 141 and 161 overlap. In the example of FIG. 3, the wireless device 2 may be sited in the geographic region 182. Each of the cells 12, 14, and 16 may provide overlapping communication coverage for the geographic region 182. Also in the example of FIG. 3, the cell 12 is a source cell. Cell 14 and cell 16 in FIG. 3 are candidate cells. These candidate cells 14 and 16 are potentially target cells in a handover of the wireless device 2 from the source cell 12. The wireless device 2, when in communication with the cell 12, maintains the downlink 131 and the uplink 133 with the cell 12. Downlink 131 is an electromagnetic wave emitted from the cell 12. The antenna module 273 may also receive signal 151 from the cell 14 and signal 171 from the cell 16. Signal 151 is an electromagnetic wave emitted from the cell 14 and signal 171 is an electromagnetic wave emitted from the cell 16.

For this example, FIG. 3 illustrates cell 12 as a source cell that that is exchanging uplink information with the wireless device 2 via the uplink 133 and is exchanging downlink information with the wireless device 2 via the downlink 131. FIG. 3 illustrates cell 14 and cell 16 as candidate cells for a possible handover. Each of the cells 12, 14, and 16 may provide overlapping communication coverage for the geographic region 182. In FIG. 3, the wireless device 2 is sited in the geographic region 182.

In the example of FIG. 3, cell 12 is a source cell. The handover processing in FIG. 4A proceeds from block 41 to block 42. In block 42 of FIG. 4A, the electronic processor 23 may determine whether or not the wireless device 2 is in wireless communication with a source cell. A Radio Resource Control (RRC) connection may exist between the wireless device 2 and the source cell when the wireless device 2 is in wireless communication with the source cell. The source cell in the example of FIG. 3 is cell 12.

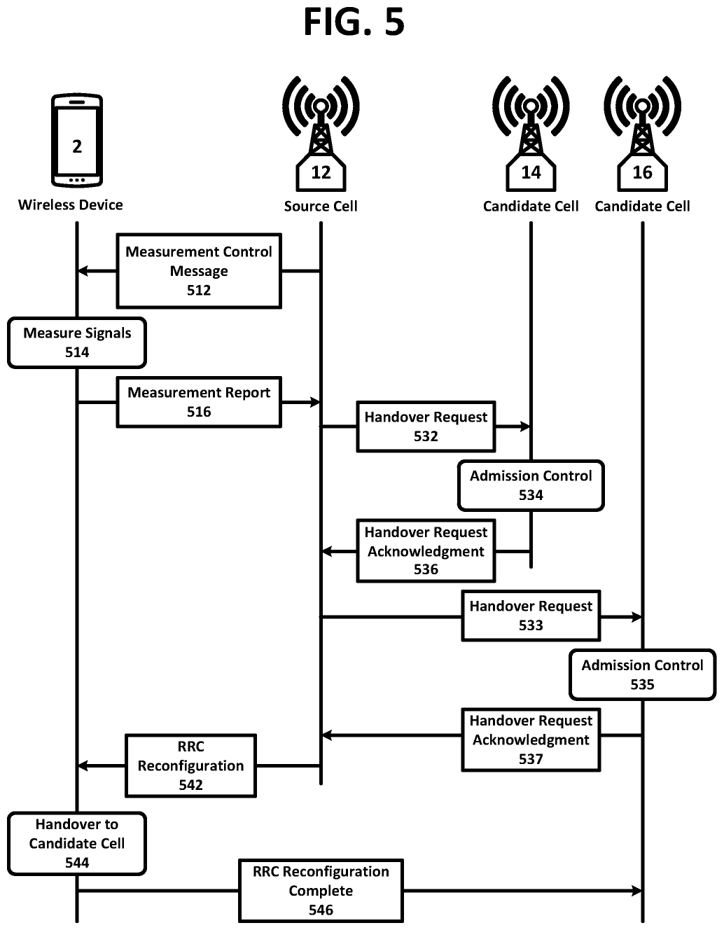

When the electronic processor 23 determines in block 42 that the wireless device 2 is not in wireless communication with the source cell, the handover processing in FIG. 4A advances from block 42 to block 43. When the handover processing in FIG. 4A advances from block 42 to block 43, the electronic processor 23 in block 43 may cause the wireless device 2 to initiate a re-establishment procedure that attempts to re-establish communication with the source cell when a failure condition occurs. The failure condition may include a radio link failure, reconfiguration failure, and/or an integrity check failure that causes a loss of the communication between the antenna module 273 and the source cell. When the electronic processor 23 determines in block 42 that the wireless device 2 is in wireless communication with the source cell, the handover processing in FIG. 4A advances to block 44 of FIG. 4A. An event trace diagram in FIG. 5 illustrates a signal flow diagram for the handover processing in FIGS. 4A, 4B, 4C and 4D.

FIG. 4B is an example of a process performed by the electronic processor 23 during block 44 of FIG. 4A. As an overview of the handover processing performed by the electronic processor 23 in block 44, FIG. 4B depicts the handover processing in block 44 to include the receipt by the wireless device 2 of a measurement control message in block 442, the decoding of the measurement control message in block 443, the measuring of signals in block 444, storing of signal values in block 445, testing for a triggering event in block 446, and the transmitting of a measurement report in block 447.

The handover processing for block 44 in FIG. 4A commences in block 441 of FIG. 4B and proceeds from block 441 to block 442. For the example illustrated in FIG. 3, cell 12 is a source cell. For the example of FIG. 3, the source cell 12 may transmit a measurement control message 512 to the wireless device 2. The event trace diagram of FIG. 5 depicts the measurement control message 512 from the source cell 12 to the wireless device 2.

In block 442 of FIG. 4B, the electronic processor 23 may control the transceiver 27 in a manner that permits the transceiver 27 to receive the measurement control message 512 from the source cell 12 when the source cell 12 transmits the measurement control message 512 to the wireless device 2. The transceiver 27 may receive the measurement control message 512 from the source cell 12 via the downlink 131. Upon receipt of the measurement control message 512 by the transceiver 27, the electronic processor 23 may decode the measurement control message 512 in block 443 of FIG. 4B. The electronic processor 23 may extract measurement criteria and reporting criteria when decoding the measurement control message 512.

The measurement criteria may specify the conditions for the wireless device 2 to perform the measurements. Specifically, the measurement criteria may include measurement objects information, measurement identities information, measurement types, and measurement gap information.

Typically, during an evaluation that assesses the practicality of a handover, a source cell in the communication system 1 may designate the cells whose signal strengths are to be measured. Measurement objects information may include information for the cells 12, 14, and 16 in the communication system 1 that the source cell designates to be measured. In the example of FIG. 3, cell 12 is the source cell, cells 14 and 16 are candidate cells, and signals from cells 12, 14, and 16 are to be measured during the evaluation.

The measurement objects may include a physical cell identification that respectively identifies each of the cells 12, 14, and 16. The measurement objects may also include a list of offset values for each of the cells 12, 14, and 16. For the downlink 131 and the signals 151, 171, respectively, the measurement objects may include a frequency channel number and a beam identifier.

Measurement identities information may be used as reference number that identifies the measurement objects in a measurement report 516 of FIG. 5.

Measurement types that are specified in the measurement criteria may include an intra-frequency measurement type, inter-frequency measurement types, and inter-RAT measurement types. An intra-frequency measurement type may instruct the electronic processor 23 to control the sensing circuitry 25 in a manner that causes the sensing circuitry 25 to measure the carrier frequency of the downlink 131 of the source cell 12. For the signals 151 and 171, the inter-frequency measurement types may instruct the electronic processor 23 to control the sensing circuitry 25 in a manner that causes the sensing circuitry 25 to measure frequencies that differ from the carrier frequency of the downlink 131. The inter-RAT measurement types may instruct the electronic processor 23 to perform measurements that may facilitate a handover of the wireless device 2 from one radio access technology (RAT) to another RAT. By incorporating the various measurement types into the measurement control message 512, the source cell 12 may request the wireless device 2 to perform the measurement types.

The electronic processor 23 may process the measurement criteria when configuring the wireless device 2 to measure the downlink 131 and signals 151 and 171. Block 514 of FIG. 5 is represented in FIG. 4B as block 444. In block 444 of FIG. 4B, the sensing circuitry 25 may measure the electromagnetic waves for the cells 12, 14, and 16 that are identified in the measurement objects. For the example of FIG. 3, the measurement objects may include the physical cell identification for the cells 12, 14, and 16. The wireless device 2 may perform the measurement types that are specified in the measurement criteria. To perform the measurement types, the electronic processor 23 may control the sensing circuitry 25 to measure the downlink 131 and signals 151 and 171 that the antenna module 273 receives from cell 12, cell 14 and cell 16.

In block 444 of FIG. 4B, upon configuring the sensing circuitry 25 to measure the downlink 131 and signals 151 and 171, the sensing circuitry 25 may perform measurements on the downlink 131 and signals 151 and 171. The measurements performed by the sensing circuitry 25 on the downlink 131 and signals 151 and 171 may permit the sensing circuitry 25 to obtain signal values for a Received Signal Reference Power (RSRP), a Received Signal Reference Quality (RSRQ), and a Signal to Interference and Noise Ratio (SINR) for each of the downlink 131 and signals 151 and 171. Measurement gap information may include periodic time intervals at which the downlink 131 and signals 151 and 171 are to be measured by the sensing circuitry 25. The sensing circuitry 25 may measure the downlink 131 and signals 151 and 171 to ascertain the RSRP, RSRQ and SINR signal values for each of the downlink 131 and signals 151 and 171, respectively.

RSRP is a type of measurement that indicates the signal strength of a measured signal. Signal values for RSRP are expressed in decibel-milliwatts (dBm), dBm being a unit of electrical power in milliwatts (mW) that is expressed on a decibel scale. Being that the decibel scale is a negative scale, a dBm value that is closer to 0 dBm is relatively better than a dBm value that is further away from 0 dBm.

RSRQ and SINR are each expressed in decibels (dB), dB being a dimensionless unit of measurement that expresses a ratio of two values. Being that the decibel scale is a negative scale, a dB value that is closer to 0 dB is relatively better than a dB value that is more negative than 0 dB. RSRQ is a type of measurement that indicates the signal quality of the measured signal. SINR is the ratio of the signal power for the measured signal to the sum of the power for interfering noise and signals.

When the sensing circuitry 25 measures the downlink 131 and signals 151 and 171 in block 444, the handover processing advances to block 445 of FIG. 4B. In block 445 of FIG. 4B, the electronic processor 23 may store the signal values into the memory 21. The handover processing in FIG. 4B advances from block 445 to block 446.

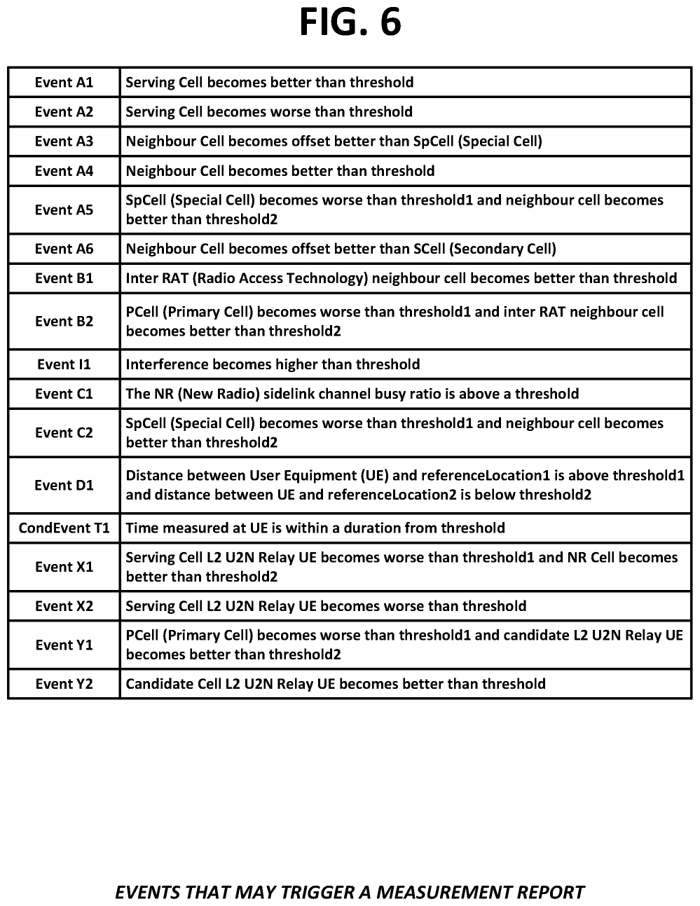

In block 446 of FIG. 4B, the electronic processor 23 may determine whether or not any value for any of the signal values measured by the sensing circuitry 25 would amount to a triggering event that would prompt the electronic processor 23 to cause the transmission of a measurement report 516 from the wireless device 2 to the source cell 12. The reporting criteria decoded by the electronic processor 23 from the measurement control message 512 may include the triggering events listed in FIG. 6. The triggering events listed in FIG. 6 may be similar to those that are found in Section 5.5.4 of Technical Specification 3GPP TS 38.331 V17.5.0 (2023-06). The handover processing advances from block 446 to block 45 of FIG. 4A when the electronic processor 23 determines in block 446 that a triggering event does not exist.

Alternatively, when the electronic processor 23 determines in block 446 that a triggering event exists, the handover processing advances from block 446 to block 447 of FIG. 4B. The existence of the triggering event may cause the wireless device 2 to output the measurement report 516 in block 447. When the electronic processor 23 in block 446 determines that at least one of the signal values measured by the sensing circuitry 25 would amount to a triggering event listed in FIG. 6, the electronic processor 23 in block 447 may control the transceiver 27 in a manner that causes the transceiver 27 to transmit the measurement report 516 to the source cell 12 via the uplink 133.

When causing the transceiver 27 to transmit the measurement report 516, the electronic processor 23 may incorporate the measurement identities information and the signal values into the uplink information. When the measurement identities information and the signal values are incorporated into the uplink information, the electronic processor 23 may transfer the uplink information to the transceiver circuitry 271. The electronic processor 23 may control the transceiver circuitry 271 in a manner that causes the transceiver circuitry 271 to superimpose the uplink information onto a baseband signal for emission by the antenna module 273 via the uplink 133 in FIG. 3. The measurement report 516 may include the measured signal values for the downlink 131 and the measured signal values for signals 151 and 171. The measurement report 516 may also include the measurement identities information to identify the measurement objects. To identify the measurement objects in the measurement report 516, the measurement identities information may respectively associate the physical cell identification for the cells 12, 14, and 16 with the signal values for the downlink 131 and signals 151 and 171. The measurement identities information may be used as reference number that identifies the measurement objects. The handover processing in block 447 of FIG. 4B may advance to block 45 of FIG. 4A.

The wireless device 2 may report, to the source cell 12 in the measurement report 516, the results of the measurements performed by the sensing circuitry 25. These results may include the signal values measured by the sensing circuitry 25. FIG. 5 illustrates receipt of the measurement report 516 by the source cell 12. Upon receipt of the measurement report 516 from the wireless device 2, the source cell 12 may initiate a handover by issuing handover requests 532, 533 to the candidate cells 14 and cell 16 respectively over interfaces interface 13 and interface 17 of FIG. 1A.

Upon receipt of the respective handover requests 532, 533 from the source cell 12, each of the candidate cells 14 and 16 may perform an admission control 534, 535 and provide handover request acknowledgments 536, 537 to the source cell 12. The handover request acknowledgments 536, 537 may each include a new radio resource control (RRC) configuration. The new RRC configuration for the candidate cell 14 includes configuration information for the candidate cell 14. The new RRC configuration for the candidate cell 16 includes configuration information for the candidate cell 16.

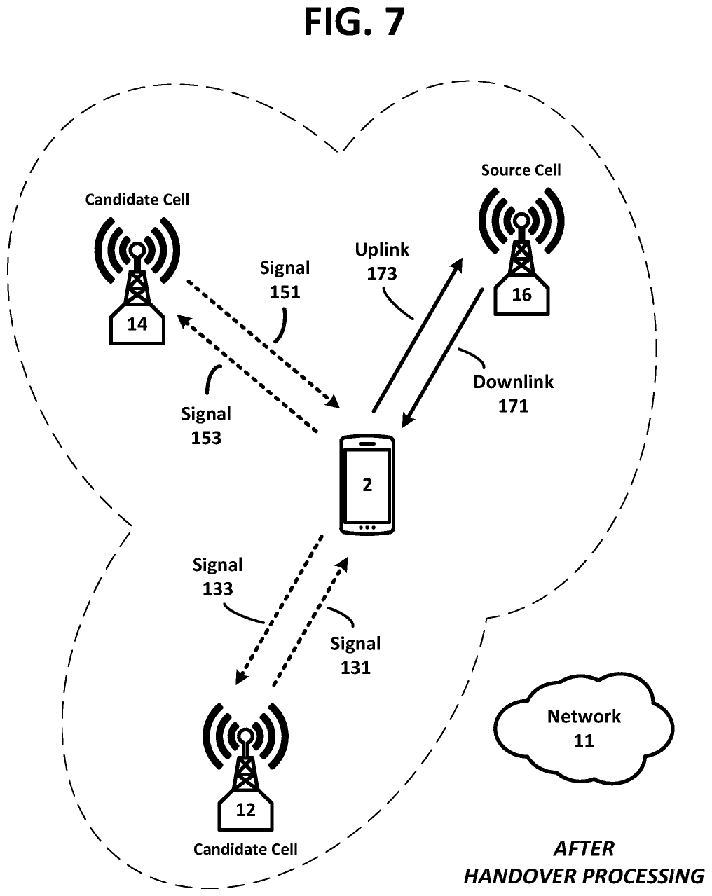

Upon receipt of the handover request acknowledgments 536, 537 from the candidate cells 14 and 16, the source cell 12 may send an RRC reconfiguration message 542 to the wireless device 2 as illustrated in FIG. 5. The RRC reconfiguration message 542 may contain the configuration information for the particular one of the candidate cells 14 and 16 that the source cell 12 selects to become a target cell. The configuration information for the target cell may also include cell identification information for the target cell and any other information required for the wireless device 2 to access the target cell. A comparison of FIGS. 3 and 7 shows that the cell 16 may become the target cell, and ultimately, a source cell.

The handover processing advances from block 45 to block 42 of FIG. 4A when the electronic processor 23 determines in block 45 that the transceiver 27 has not transmitted the measurement report 516. Alternatively, when the electronic processor 23 determines that the transceiver 27 has transmitted the measurement report 516, the handover processing advances from block 45 to block 46 of FIG. 4A.

In block 46, the electronic processor 23 may determine whether or not a condition for a legacy handover is present. The electronic processor 23 may control the legacy handover. A condition for the legacy handover may exist when the transceiver 27 has timely received the RRC reconfiguration message 542 from a source cell. In block 46, the electronic processor 23 may assess whether or not the transceiver 27 has received the RRC reconfiguration message 542 from the source cell 12 before the expiration of a predetermined amount of time. The electronic processor 23 may extract, from the measurement control message 512, time lapse information that specifies the predetermined amount of time. The time lapse information may be information that the wireless device receives from the source cell. Alternatively, the electronic processor 23 may receive the time lapse information from a source other than the measurement control message 512. The electronic processor 23 may store the time lapse information into memory 21 prior to executing the handover processing of FIG. 4A. For example, the time lapse information may be designated from a setting entered by a user or may be designated by a factory setting.

FIG. 4C is an example of a process performed by the electronic processor 23 during block 46 of FIG. 4A. As an overview of the handover processing performed by the electronic processor 23 in block 46, FIG. 4C depicts the handover processing in block 46 to include the measuring for a lapse of a time span in block 462, the testing for receipt of the RRC reconfiguration message in block 463, the performing of the legacy handover in block 464, and the testing for the elapsed of time receipt in block 465. The handover processing for block 46 in FIG. 4A starts in block 461 of FIG. 4C and proceeds from block 461 to block 462.

In block 462, the electronic processor 23 may, from the instant that the transceiver 27 transmits the measurement report 516 to the source cell 12, commence measuring a span of time that elapses. The handover processing in FIG. 4C proceeds from block 462 to block 463.

In block 463, the electronic processor 23 may determine whether or not the transceiver 27 has received the RRC reconfiguration message 542. A condition for the legacy handover may exist when the transceiver 27 has timely received the RRC reconfiguration message 542 from a source cell. In the example of FIG. 3, the cell 12 is the source cell. Cell 14 and cell 16 in FIG. 3 are candidate cells. These candidate cells 14 and 16 are potentially target cells in the legacy handover of the wireless device 2 from the source cell 12. The antenna module 273 may receive the RRC reconfiguration message 542 via the downlink 131. The handover processing advances from block 463 to block 464 when the electronic processor 23 determines in block 463 that the transceiver 27 has received the RRC reconfiguration message 542. Under the circumstance when the handover processing in FIG. 4C advances from block 463 to block 464, block 464 may be represented in FIG. 5 as block 544. Operationally, only when the transceiver 27 receives the RRC reconfiguration message 542 before the expiration of the predetermined amount of time will the handover processing advance from block 463 to block 464.

Upon receipt of the RRC reconfiguration message 542 by the transceiver 27, the electronic processor 23 may decode the RRC reconfiguration message 542 in block 464. When decoding the RRC reconfiguration message 542, the electronic processor 23 may extract the configuration information from the RRC reconfiguration message 542. The configuration information may include information for the particular one of the candidate cells 14 and 16 that the source cell 12 selects to become the target cell. The configuration information for the target cell may also include cell identification information for the target cell and any other information required for the wireless device 2 to access the target cell during the legacy handover.

In block 464, the transceiver 27 may convert the configuration information into downlink information when the antenna module 273 receives the RRC reconfiguration message 542 via the downlink 131. The electronic processor 23 may extract the configuration information from the downlink information.

The electronic processor 23 may obtain, from the downlink information, the configuration information for the target cell 16 in block 464. When the electronic processor 23 obtains the configuration information for the target cell 16, the electronic processor 23 may process the configuration information so as to permit the electronic processor 23 to control the transceiver 27 in a manner that causes the transceiver 27 transmit the RRC reconfiguration complete message 546 of FIG. 5 to the newly-designated source cell 16. The RRC reconfiguration complete message 546 is a command that causes the communication system 1 to perform the legacy handover by relocating the communication for the wireless device 2 from the source cell 12 to the target cell 16. When the transceiver 27 transmits the RRC reconfiguration complete message 546 in block 464, the transceiver 27 may release the downlink 131 and the uplink 133 with the cell 12 and establish a new downlink 171 and a new uplink 173 with the cell 16.

FIG. 7 illustrates the wireless device in the communication system after the electronic processor 23 performs the legacy handover in block 464. The target cell 16 may become a newly-designated source cell 16 and the previous source cell 12 may become another candidate cell 12 as illustrated in the example of FIG. 7. When the transceiver 27 moves the communication to the newly-designated source cell 16 in block 464, the electronic processor 23 may control the transceiver 27 in a manner that causes the transceiver 27 transmit the RRC reconfiguration complete message 546 of FIG. 5 to the newly-designated source cell 16. The handover processing then proceeds from block 464 to block 42 of FIG. 4A with cell 16 replacing cell 12 as the source cell in block 464.

The handover processing in FIG. 4C advances from block 463 to block 465 of FIG. 4C when the electronic processor 23 determines in block 463 that the transceiver 27 has not received the RRC reconfiguration message 542. In block 465, the electronic processor 23 may process the time lapse information to determine whether or not the predetermined amount of time has elapsed. The predetermined amount of time begins from the instant that the transceiver 27 transmits the measurement report 516 to the source cell 12 in block 447 of FIG. 4B. The handover processing in FIG. 4C returns from block 465 to block 463 when the electronic processor 23 determines in block 465 that the predetermined amount of time has not elapsed.

The predetermined amount of time elapses when the transceiver 27 has not received the RRC reconfiguration message 542 prior to the expiration of the predetermined amount of time. A relatively weak signal between the source cell and the wireless device 2 may cause the expiration of the predetermined amount of time. Cell 12 is the source cell in the example of FIG. 3. The weak signal may be the result of factors that may include the physical characteristics of the source cell, the geography of the coverage areas 121, 141, 161, and the existence of a weather phenomenon. The weather phenomenon that may affect the signal strength may include an environmental condition such as wind, atmospheric humidity, thunder and lightning, rain, snow, and ice. The distance from the wireless device 2 to the source cell may be the cause of the weak signal. The geography of the coverage areas 121, 141, 161 may result in the existence of dead spots in the coverage areas 121, 141, 161. The physical characteristics of the source cell that may contribute to the weakness of the signal may include the transmitter power of the source cell and the processing power of power of the source cell. Other factors may also affect the signal between the source cell and the wireless device 2.

When the electronic processor 23 determines in block 465 that the predetermined amount of time has elapsed, the handover processing in FIG. 4C advances from block 465 to block 47 in FIG. 4A. Under the circumstance when the handover processing in FIG. 4C advances from block 465 to block 47, block 47 of FIG. 4A may be represented in FIG. 5 as block 544.

In block 47, the electronic processor 23 may process the measurement objects information and the measured signal values to obtain the configuration information for a conditional handover. The measurement objects information in block 47 may include the measurement objects information extracted by the electronic processor 23 in block 443 of FIG. 4B. Specifically, the measurement objects may include the physical cell identification for the cells 12, 14, and 16 and the beam identifiers for the downlink 131 and signals 151 and 171. The measurement objects may also include the frequency channel numbers for the downlink 131 and signals 151 and 171. In block 444 of FIG. 4B, the sensing circuitry 25 may measure signals 151 and 171 to ascertain the RSRP, RSRQ and SINR signal values for signals 151 and 171, respectively. The measured signal values processed by the electronic processor 23 during block 47 of FIG. 4A may include the signal values measured by the sensing circuitry 25 in block 444 of FIG. 4B.

FIG. 4D is an example of a process performed by the electronic processor 23 during block 47 of FIG. 4A. As an overview of the handover processing performed by the electronic processor 23 in block 47, FIG. 4D depicts the handover processing in block 47 to include the retrieval of the signal values in block 472, the testing of a signal value for RSRP in block 473, the testing of a signal value for SINR in block 474, and the performing of the conditional handover in block 475. The handover processing for block 47 in FIG. 4A starts in block 471 of FIG. 4D and proceeds from block 471 to block 472.

In block 472, the electronic processor 23 may ascertain the signal values by retrieving the signal values from the memory 21. The electronic processor 23 may store the signal values into the memory 21 in block 445 of FIG. 4B. The handover processing proceeds from block 472 to blocks 473 and 474 of FIG. 4D. FIG. 4D depicts the electronic processor 23 performing block 473 before block 474. However, as long as blocks 473 and 474 are performed between block 472 and block 475, the electronic processor 23 may perform block 474 before block 473 with the electronic processor 23 performing block 473 after block 474.

The electronic processor 23, in blocks 473 and 474, may determine an existence or absence of a conditional handover state that comprises the RSRP for the downlink 131 being below an RSRP threshold and the SINR of the downlink 131 being below an SINR threshold.

In block 473, the electronic processor 23 may determine whether or not the RSRP of the downlink 131 is below an RSRP threshold. RSRP is a type of measurement that indicates the signal strength of a measured signal. Signal values for RSRP are expressed in decibel-milliwatts (dBm), dBm being a unit of electrical power in milliwatts (mW) that is expressed on a decibel scale. Being that the decibel scale is a negative scale, a dBm value that is closer to 0 dBm is relatively better than a dBm value that is further away from 0 dBm. In this example, the RSRP threshold is −113 dBm and the RSRP is below the RSRP threshold when the RSRP is less than −113 dBm.

When the electronic processor 23 determines in block 473 that the RSRP of the downlink 131 not below the RSRP threshold, the handover processing advances from block 473 of FIG. 4D to block 42 of FIG. 4A without the electronic processor 23 performing the conditional handover in block 475.

Alternatively, the handover processing advances from to block 473 to block 474 when the electronic processor 23 determines in block 473 that the RSRP of the downlink 131 is below the RSRP threshold.

In block 474, the electronic processor 23 may determine whether or not the SINR of the downlink 131 is below an SINR threshold. SINR is a type of measurement that indicates the signal quality of the measured signal. Signal values for SINR are expressed in decibels (dB), dB being a dimensionless unit of measurement that expresses a ratio of two values. A dB value for the SINR that is less negative is relatively better than a dB value that is more negative. In this example, the SINR threshold is −4 dB and the SINR is below the SINR threshold when the SINR is less than −4 dB.

When the electronic processor 23 determines in block 474 that the SINR of the downlink 131 not below the SINR threshold, the handover processing advances from block 474 of FIG. 4D to block 42 of FIG. 4A without the electronic processor 23 performing the conditional handover in block 475.

Alternatively, the handover processing advances from to block 474 to block 475 when the electronic processor 23 determines in block 474 that the SINR of the downlink 131 is below the SINR threshold.

To determine in block 475 which one of the signals 151 and 171 that the wireless device 2 may best receive, the electronic processor 23 may retrieve the RSRP, RSRQ and SINR signal values from the memory 21. The signal values retrieved by the electronic processor 23 during block 475 may include the signal values measured by the sensing circuitry 25 in block 444 of FIG. 4B. In block 475 of FIG. 4D, the electronic processor 23 may process the RSRP, RSRQ and SINR signal values for signals 151 and 171.

For the example of FIG. 7, the electronic processor 23 may determine in block 475 that the wireless device 2 best receives signal 171 from cell 16. When the electronic processor 23 determines that the wireless device best receives signal 171, for example, the electronic processor 23 in block 475 may control the wireless device 2 in a manner that causes the wireless device 2 to perform the conditional handover that relocates the communication between the wireless device 2 and the network 11 from the source cell 12 to the target cell 16.

The measurement objects extracted from the measurement criteria by the electronic processor 23 in block 443 may include the frequency channel number, the beam identifier, and the physical cell identification for each of the cells 12, 14, and 16. When the electronic processor 23 obtains the measurement objects for the target cell 16, the electronic processor 23 may process the measurement objects so as to permit the electronic processor 23 to control the transceiver 27 in a manner that causes the transceiver 27 transmit the RRC reconfiguration complete message 546 of FIG. 5 to the newly-designated source cell 16. The RRC reconfiguration complete message 546 is a command that causes the communication system 1 to perform the conditional handover by relocating the communication from the source cell 12 to the target cell 16. When the transceiver 27 transmits the RRC reconfiguration complete message 546 in block 475, the transceiver 27 may release the downlink 131 and the uplink 133 with the cell 12 and establish a new downlink 171 and a new uplink 173 with the cell 16.

When the transceiver 27 moves the communication from the source cell 12 to the target cell 16, the transceiver 27 may release the downlink 131 and the uplink 133 with the cell 12 and establish a new downlink 171 and a new uplink 173 with the cell 16. The target cell 16 may become a newly-designated source cell 16 and the previous source cell 12 may become another candidate cell 12 as illustrated in the example of FIG. 7. When the transceiver 27 moves the communication to the newly-designated source cell 16, the electronic processor 23 may control the transceiver 27 in a manner that causes the transceiver 27 transmit an RRC reconfiguration complete message 546 of FIG. 5 to the newly-designated source cell 16.

Alternatively, when the electronic processor 23 determines in block 474 that the SINR of the downlink 131 is not below the SINR threshold, the handover processing advances from block 474 of FIG. 4D to block 42 of FIG. 4A without the electronic processor 23 performing the conditional handover in block 475.

Benefits of the handover processing as illustrated in FIGS. 4A, 4B, 4C and 4D and described herein may include an improved operability and reliability of communication by the wireless device 2 in a communication system. Other benefits may include a reduction in the loss of communication between the wireless device 2 in a communication system. The handover processing as illustrated in FIGS. 4A, 4B, 4C and 4D and described herein may improve the handover success rate of a cell and network. The handover processing as illustrated in FIGS. 4A, 4B, 4C and 4D and described herein may also improve mobility robustness and user experience as enhancement for RRC connection reliability. In the case of an RRC connection failure between universal equipment (UE) and a network, performing the handover processing as illustrated in FIGS. 4A, 4B, 4C and 4D and described herein instead of first performing a re-establishment may mitigate RRC connection failures in the network up to a certain extent by having another way of handover.

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor, also referred to as an electronic processor, (e.g., a serial or parallel processor chip or specialized processor chip, a single-or multi-core chip, a microprocessor, a field programmable gate array, any variety of combinations of a control unit, arithmetic logic unit, and processor register, and so on), a computer (e.g., a processor operatively coupled to a memory), or another electronically operated controller to implement aspects detailed herein. Accordingly, for example, examples of the technology can be implemented as a set of instructions, tangibly embodied on a non-transitory computer-readable media, such that a processor can implement the instructions based upon reading the instructions from the computer-readable media. Some examples of the technology can include (or utilize) a control device such as, e.g., an automation device, a special purpose or programmable computer including various computer hardware, software, firmware, and so on, consistent with the discussion herein. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

Certain operations of methods according to the technology, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular examples of the technology. Further, in some examples, certain operations can be executed in parallel or partially in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as, e.g., “either,” “only one of,” or “exactly one of.”

In the description above and the claims below, the term “connected” can refer to a physical connection or a logical connection. A physical connection indicates that at least two devices or systems co-operate, communicate, or interact with each other, and are in direct physical or electrical contact with each other. For example, two devices are physically connected via an electrical cable. A logical connection indicates that at least two devices or systems co-operate, communicate, or interact with each other, but may or may not be in direct physical or electrical contact with each other. Throughout the description and claims, the term “coupled” may be used to show a logical connection that is not necessarily a physical connection. “Co-operation,” “the communication,” “interaction” and their variations include at least one of: (i) transmitting of information to a device or system; or (ii) receiving of information by a device or system.

The word “exemplary” is used herein to mean serving as an example, instance, or illustration. Any aspect or design described herein as “exemplary” is not necessarily to be construed as preferred or advantageous over other aspects or designs.

Any mark, if referenced herein, may be common law or registered trademarks of third parties affiliated or unaffiliated with the applicant or the assignee. Use of these marks is by way of example and shall not be construed as descriptive or to limit the scope of disclosed or claimed embodiments to material associated only with such marks.

Although the present technology has been described by referring to certain examples, workers skilled in the art will recognize that changes can be made in form and detail without departing from the scope of the discussion.

What is claimed is:

1. A wireless device comprising:
a transceiver configured to:
receive, as electromagnetic waves, signals emitted wirelessly from a plurality of cells;
sensing circuitry configured to:
measure, for one of the signals from a source cell, a signal to interference and noise ratio (SINR) and a received signal reference power (RSRP); and
an electronic processor configured to:
control, when the transceiver receives a reconfiguration message from the source cell during a time span, a legacy handover that shifts communication with the transceiver from the source cell to the target cell, and
control, when the electronic processor determines the existence of a conditional handover state, a conditional handover that shifts communication with the transceiver from the source cell to the target cell,
wherein:
the source cell is one of the cells and the target cell is another of the cells, and
the conditional handover state comprises an absence of the legacy handover, the RSRP being below an RSRP threshold and the SINR below an SINR threshold.

2. The wireless device of claim 1, wherein the RSRP threshold is −113 dBm.

3. The wireless device of claim 1, wherein the SINR threshold is −4 dB.

4. The wireless device of claim 1, wherein the reconfiguration message comprises configuration information for a particular one of the cells that the source cell may select to become the target cell.

5. The wireless device of claim 1, wherein the reconfiguration message comprises configuration information for a particular one of the cells that the source cell selects to become the target cell.

6. The wireless device of claim 1, wherein the electronic processor is configured to:
store, into memory when the sensing circuitry measures the signals from the cells, signal values for the signals received wirelessly by the transceiver.

7. The wireless device of claim 1 further comprising:
a bus configured to electronically connect the electronic processor to the sensing circuitry and the transceiver.

8. The wireless device of claim 1, further comprising:
a housing configured to encase the transceiver, the sensing circuitry, and the electronic processor.

9. A conditional handover method comprising:
receiving by a transceiver, as electromagnetic waves, signals emitted wirelessly from a plurality of cells;
measuring by sensing circuitry, for one of the signals from a source cell, a signal to interference and noise ratio (SINR) and a received signal reference power (RSRP);
controlling by an electronic processor, when the transceiver receives a reconfiguration message from the source cell during a time span, a legacy handover that shifts communication with the transceiver from the source cell to the target cell;
controlling by the electronic processor, when the electronic processor determines the existence of a conditional handover state, a conditional handover that shifts communication with the transceiver from the source cell to the target cell,
wherein:
the source cell is one of the cells and the target cell is another of the cells, and
the conditional handover state comprises an absence of the legacy handover, the RSRP being below an RSRP threshold and the SINR below an SINR threshold.

10. The conditional handover method of claim 9, wherein the reconfiguration message comprises configuration information for a particular one of the cells that the source cell selects to become the target cell.

11. The conditional handover method of claim 9, wherein the reconfiguration message comprises configuration information for a particular one of the cells that the source cell selects to become the target cell.

12. The conditional handover method of claim 9, wherein further comprising:
controlling by the electronic processor, when the sensing circuitry measures the signals to obtain signal values, memory to store the signal values for the signals.

13. The conditional handover method of claim 9, further comprising:
connecting, electronically by a bus, the electronic processor to the sensing circuitry and the transceiver.

14. The conditional handover method of claim 9, further comprising:
encasing the transceiver, the sensing circuitry, and the electronic processor in a housing.

15. A non-transitory computer readable medium comprising computer readable program code that is executable by an electronic processor,
the computer readable program code when executed by the electronic processor causing the electronic processor to:
control a transceiver to receive, as electromagnetic waves, signals emitted wirelessly from a plurality of cells;
control sensing circuitry to measure, for one of the signals from a source cell, a signal to interference and noise ratio (SINR) and a received signal reference power (RSRP);
control the transceiver to perform, when the transceiver receives a reconfiguration message from the source cell during a time span, a legacy handover that shifts communication with the transceiver from the source cell to the target cell; and
control the transceiver to perform, when the electronic processor determines the existence of a conditional handover state, a conditional handover that shifts communication with the transceiver from the source cell to the target cell,
wherein:
the source cell is one of the cells and the target cell is another of the cells, and
the conditional handover state comprises an absence of the legacy handover, the RSRP being below an RSRP threshold and the SINR below an SINR threshold.

16. The non-transitory computer readable medium of claim 15, wherein the reconfiguration message comprises configuration information for a particular one of the cells that the source cell selects to become the target cell.

17. The non-transitory computer readable medium of claim 15, the computer readable program code when executed by the electronic processor further causing the electronic processor to:
store, into memory when the sensing circuitry measures the signals from the cells, signal values for the signals received wirelessly by the transceiver.

18. The non-transitory computer readable medium of claim 17, wherein the memory comprises the computer readable medium.

19. The non-transitory computer readable medium of claim 15, wherein a bus electronically connects the electronic processor to the sensing circuitry and the transceiver.

20. The non-transitory computer readable medium of claim 15, wherein a housing encases the transceiver, the sensing circuitry, and the electronic processor.
